(19) United States
(12) Patent Application Publication
(10) Pub. No.: US 2022/0281195 A1
(43) Pub. Date: Sep. 8, 2022

(54) METHOD FOR PRODUCING A CONTINUOUS BELT

(71) Applicant: Berndorf Innovations und Technologie GmbH, Berndorf (AT)

(72) Inventors: Markus HAYDN, Guntramsdorf (AT); Thomas STUECKLER, Ternitz (AT); Pelin SUEALP, Vienna (AT); Richard SZIGETHI, Neudoerfl (AT)

(73) Assignee: Berndorf Innovations und Technologie GmbH, Berndorf (AT)

(21) Appl. No.: 17/631,582

(22) PCT Filed: Jul. 30, 2020
(86) PCT No.: PCT/AT2020/060284

§ 371 Date: Jan. 31, 2022

(30) Foreign Application Priority Data
Aug. 1, 2019 (AT) A50695/2019

(51) Int. Cl. B29D 29/00; F16G 1/20

(52) U.S. Cl. CPC B29D 29/00; F16G 1/20

(57) ABSTRACT

A method produces an endless belt having a belt body, which includes a first main surface and a second main surface, wherein the first main surface and the second main surface of the belt body are connected to one another via lateral edges, wherein a coating is applied to the first main surface of the belt body being opposite to an inner side of the endless belt in a finished state of the endless belt, wherein the coating forms an outer side of the endless belt in a finished state, wherein at least one base material, into which reinforcing elements are inserted, is applied to the first main surface of the belt body as the coating.

The invention relates to a method for producing an endless belt with a belt body, having a first main surface and a second main surface, wherein the first main surface and the second main surface of the belt body are connected to one another via lateral edges, wherein a coating is applied to the first main surface of the belt body being opposite to an inner side of the endless belt in a finished state of the endless belt, wherein the coating forms an outer side of the end- less belt in a finished state.

The invention further relates to an endless belt with a belt body, having a first main surface and a second main surface, wherein the first main surface and the second main surface of the belt body are connected to one another via lateral edges, wherein a coating is applied to the first main surface of the belt body being opposite to an inner side of the endless belt, wherein the coating forms an outer side of the endless belt.

Belts for vehicle test rigs, wind tunnels and the like often have surface coverings and/or coat- ings that can tend to formation of cracks under continuous load, as these are often adhesive films.

Thus, it is an object of the present invention to overcome the shortcomings of the known solu- tions and to provide an endless belt for the use in vehicle test rigs and wind tunnels, which has a mechanically very hard-wearing coating that does not break or tear or detach from the end- less belt even under continuous loads.

This object is achieved by a method of the initially mentioned type according to the invention in that at least one base material, into which reinforcing elements are inserted, is applied to the first main surface of the belt body as a coating.

By the solution according to the invention, tearing, breaking or detaching of the coating may be prevented also in case of very small bending radii of the endless belt and under continuous loads. Moreover, the solidity, resistance and long-term performance of the coating are im- proved significantly.

It has proved to be particularly advantageous if fibers, in particular mineral fibers, such as car- bon fibers and/or boron fibers, and/or plastic fibers and/or glass fibers, such as nylon fibers (e.g. polyamide), and/or metal fibers and/or fibers based on natural raw materials, such as cel- lulose and/or hemp and/or cotton and/or sisal and/or jute and/or flax and/or natural fibers (seed fibers, bast fibers, hard fibers, coir, rush grasses, bamboo, etc.) and/or wood fibers and/or wool and/or animal hair and/or silk, and/or needles, in particular metal needles, are used as reinforcing elements.

The reinforcing elements may form at least a long-range order, for example in the form of a mesh, grid or fabric, such as an armoring fabric, in particular in the form of a biaxial glass fabric, or in the form of a glass fiber scrim or carbon fiber scrim, or may be statistically dis- tributed in the base material, for example in the form of cotton flocks, glass fiber shavings, carbon fiber shavings.

It has proven to be particularly favorable with respect to the resistance of the coating under continuous load for the reinforcing elements to each have a ratio of length to diameter of at least 3:1, in particular of at least 5:1, preferably of at least 7:1, particularly preferred of at least 8:1.

Moreover, an advancement of the invention according to which a share of the reinforcing ele- ments amounts to between 10 and 45 percent by weight, in particular between 20 and 35 per- cent by weight, of the base material or the coating, has proven to be particularly advanta- geous.

According to an advantageous advancement of the invention, it may be provided that the base material forms a matrix for hard particles, into which the hard particles, which consist in par- ticular of at least one material with a hardness measured according to Vickers of more than 500 [HV], preferably with a hardness between 1400 [HV] and 10060 [HV], are embedded, wherein the coating is preferably applied directly to the first main surface of the belt body. In this variant of the invention, on the one hand, a coating with an average roughness, in particu- lar an average roughness depth, and/or an average surface finish and/or structure can be achieved, which corresponds to an average road coating and/or at least a coating can be real- ized, which approaches a road coating optically and/or with regard to the skid resistance, on the other hand, the coating can be applied directly to the surface of the belt body and very good adhesion can be achieved. On the other hand, the coating can be applied directly to the surface of the belt body and very good adhesion between the coating and belt body can be achieved without the need for an additional adhesion promoter layer. Moreover, the applied coating fulfills a protective function for the belt body, in particular regarding impulse, strike and shear forces as well as against corrosion.

It was found to be particularly advantageous with regard to an optimum adhesion to the sur- face of the belt body if the base material is made of at least one polymer or a mixture of poly- mers, in particular selected from the group of polyimide (PI), polypropylene (PP), monoaxi- ally oriented polypropylene (MOPP), biaxially oriented polypropylene (BOPP), polyethylene (PE), polyphenylene sulfide (PPS), polyetheretherketone (PEEK) polyetherketone (PEK), pol- yethyleneimide (PEI), polysulfone (PSU), Polyaryletherketone (PAEK), Polyethylene naph- thalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), poly- vinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroeth- ylene-hexafluoropropylene-fluoropolymer (EFEP), preferably a thermoplastic polymer. The base material forming the matrix for the hard particles may be solvent-based, for example, a hydrocarbon mixture may be used as the solvent. It is particularly advantageous if the matrix ensures sufficient flexibility compared to the belt material, as is ensured by many plastic ma- terials, especially thermoplastics. Due to the manufacturing process, the matrix may also con- tain other substances, whereby after evaporation of the solvent the predominant part of the matrix consists of polymers.

Preferably organic particles, in particular wheat grit, particles from nut shells, rice or particles from broken cherry stones, and/or inorganic particles, in particular selected from the group, corundum (A12O3), ruby, sapphire, quartz (SiO2), topaz (A12[(F,OH)2|SiO4]), silicon carbide (SiC), diamond (C), boron nitride (BN), aggregated diamond nanorods (ADNR), ZrO2and any possible dopants of ZrO2, in particular 8YSZ and 3 YSZ, sand, TiO2, metal or ceramic powders and inorganic agglomerates, may be used as hard particles.

In order to achieve a high mechanical load capacity of the endless belt, the belt body may be made of metal, wherein the belt body is closed, in particular by welding, to form an endless ring before the coating is applied. In this regard, the belt body of the endless belt may be made of a sheet metal, the end edges of which are welded together such that a closed ring is formed. However, the belt body may also be made of a sheet metal, the longitudinal edges of which are arranged helically and have a helical longitudinal weld seam, as became known for example from US3728066A. Alternatively to the use of merely one single sheet metal for pro- ducing the belt body, multiple sheet metals welded together may be used as well. Thus, the belt body may be formed of two or multiple sheet metals, the longitudinal edges and end edges of which are welded together, such that a closed ring with a desired width and length may be produced, as became known for example from AT514722B1.Alternatively, the end- less belt may also be made of a plastic material or a fiber-like material, such as carbon fibers.

The application of the coating onto the endless belt is simplified by the belt bode closed to an endless ring being circumferentially arranged between two rollers before the application of the coating.

A uniform and seamless coating may be achieved in that the base material with the reinforc- ing elements, which in a dried state represents the matrix for the hard particles, is applied in a liquid, in particular viscous form, preferably in viscous form with a dynamic viscosity of 10²—10⁵ mPas, in particular 10⁴ —10⁵ mPas, preferably together with the hard particles, to the first main surface of the belt body and is distributed uniformly on the first main surface of the belt body, in particular by means of a doctor blade, preferably by means of a strip-shaped doctor blade. By this variant of the invention, an entirely uniform coating may be achieved which has no junction points, which could result in detachment, tearing or breaking of the coating under continuous load.

The base material may, preferably together with the reinforcing elements and the hard parti- cles, be applied to the belt surface for example by spraying, rolling, trowelling, brushing and similar methods.

Preferably, the base material, the reinforcing elements and the hard particles are applied to an upper run of the belt body formed into a closed ring and distributed uniformly on the upper run by means of the doctor blade, wherein the belt body is moved further in a circumferential direction during or after the distribution of the base material and the hard particles. The upper run of the endless belt comprises an upper section of the endless belt located between the two deflection rollers as well as an upper section of the endless belt resting on the deflection roll- ers. The lower part of the endless belt opposite the upper run is referred to as lower run.

A variant of the invention in which the hard particles are mixed into the base material forming the matrix for the hard particles and the reinforcing elements before the application to the first main surface of the belt body has proved to be particularly advantageous with regard to the efficiency of the application of the coating.

Hard particles with a particle size between 0.01 and 3 mm preferably between 0.05 to 2 mm, particularly preferred between 0.1 to 1 mm, have proven to be particularly suitable for realiz- ing the invention. The values given here represent an average value of the particle size.

The aforementioned object may also be achieved by an endless belt of the initially mentioned type according to the invention in that the coating comprises a base material into which rein- forcing elements are inserted.

Advantageously, the reinforcing elements are designed as fibers, in particular mineral fibers, such as carbon fibers and/or boron fibers, and/or glass fibers and/or plastic fibers, such as ny- lon fibers (e.g. polyamide), and/or metal fibers and/or fibers based on natural raw materials, such as cellulose and/or hemp and/or cotton and/or sisal and/or jute and/or flax and/or natural fibers and/or wood fibers and/or wool and/or animal hair and/or silk, and/or as needles, in par- ticular metal needles.

It has proven to be advantageous that the reinforcing elements form at least a long-range or- der, for example in the form of a mesh, grid or fabric, such as an armoring fabric, in particular in the form of a biaxial glass fabric, or in the form of a glass fiber scrim or carbon fiber scrim, or may be statistically distributed in the base material, for example in the form of cotton flocks, glass fiber shavings, carbon fiber shavings.

According to a particularly preferred embodiment of the invention, it may be provided that the reinforcing elements each have a ratio of length to diameter of at least 3:1, in particular of at least 5:1, preferably of at least 7:1, particularly preferred of at least 8:1.

Preferably, a share of the reinforcing elements amounts to between 10 and 45 percent by weight, in particular between 20 and 35 percent by weight, of the base material or the coating.

According to an advantageous advancement of the invention, it may be provided that the base material forms a matrix, into which hard particles, in particular of at least one material with a hardness measured according to Vickers of more than 500 [HV], preferably with a hardness between 1400 [HV] and 10060 [HV], are embedded, wherein the coating is preferably applied directly to the first main surface of the belt body.

In a preferred embodiment, it is provided that the base material is made of at least one poly- mer or a mixture of polymers, in particular selected from the group of polyimide (PI), poly- propylene (PP), monoaxially oriented polypropylene (MOPP), biaxially oriented polypropyl- ene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Poly- carbonate (PC), Cycloolefin copolymers (COC), Polyoxymethylene (POM), Acrylonitrile-bu- tadiene-styrene (ABS), polyvinyl carbonate (PVC), ethylene tetrafluoroethylene (ETFE), pol- ytetrafluoroethylene (PTFE), polyvinyl fluoride (PVF), polyvinylidene fluoride (PVDF) and/or ethylene-tetrafluoroethylene-hexafluoropropylene-fluoropolymer (EFEP), preferably a thermoplastic polymer.

A variant, in which the hard particles are organic particles, in particular wheat grit, particles from nut shells, rice or particles from broken cherry stones, and/or inorganic particles, in par- ticular selected from the group, corundum (A12O3), ruby, sapphire, quartz (SiO2), topaz (A12[(F,OH)2|SiO4]), silicon carbide (SiC), diamond (C), boron nitride (BN), aggregated dia- mond nanorods (ADNR), ZrO2 and any possible dopants of ZrO2, in particular 8YSZ and 3YSZ, sand, TiO2, metal or ceramic powders and inorganic agglomerates, has proven particu- larly advantageous.

Preferably, the hard particles have a grain size of between 0.01 and 3 mm, preferably between 0.05 to 2 mm, particularly preferred between 0.1 and 1 mm.

Moreover, it has proven to be particularly advantageous if a surface of the coating comprises 1 to 10000, preferably 1 to 1000, particularly preferred 10 to 1000, hard particles per cm².

In an advancement of the invention which is particularly well suited for applications in vehi- cle test rigs, wind tunnels and the like, it is provided that the coating has a slip resistance of R13 according to DIN-51130 in a dry and in a wet surface condition.

A high mechanical load-bearing capacity of the endless belt may be achieved by the belt body being made of metal, in particular steel.

It has proven particularly advantageous in terms of adhesion to the belt body and realization of a good simulation of road conditions for the coating to have a layer thickness of between 0.1 and 5 mm, in particular between 0.5 and 1.5 mm.

Moreover, it has proven to be advantageous if the coating has an average roughness depth of more than 100 μm, preferably of more than 300 μm, particularly preferred of more than 500 μm.

In an embodiment of the invention which is particularly suitable for the use as a wheel drive belt in vehicle test rigs or in wind tunnels and the like, it is provided that the endless belt has a circumferential length of between 0.2 and 30 m, in particular between 1 and 25 m and a thick- ness of between 0.1 and 4 mm, in particular between 0.2 and 2.5 mm and a width of between 0.1 and 10 m, in particular between 0.2 and 3.2 m.

The permanent load-bearing capacity of the coating can be substantially increased by the coat- ing being seamless. In this variant of the invention, the coating has no discernible start and end points, as would be the case, for example, if a film were used, but instead merges into it- self without any discontinuity points.

For the purpose of better understanding of the invention, it will be elucidated in more detail by means of the figures below.

These show in a respectively very simplified schematic representation:

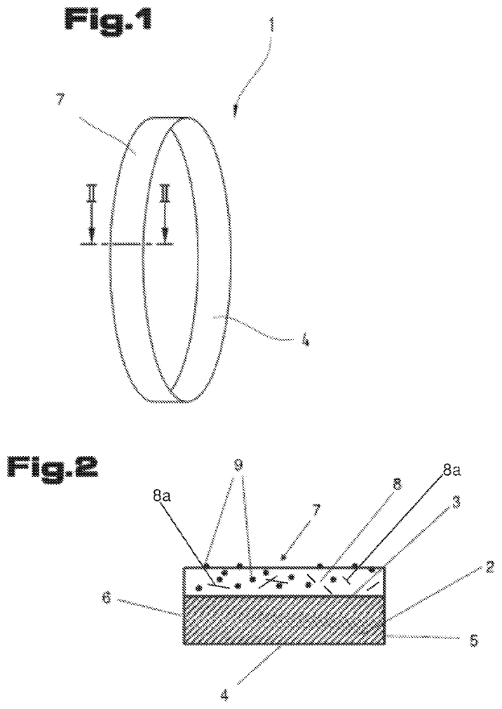

FIG. 1 a perspective view of an endless belt according to the invention;

FIG. 2 a section along the line II-II in Fig.1, and

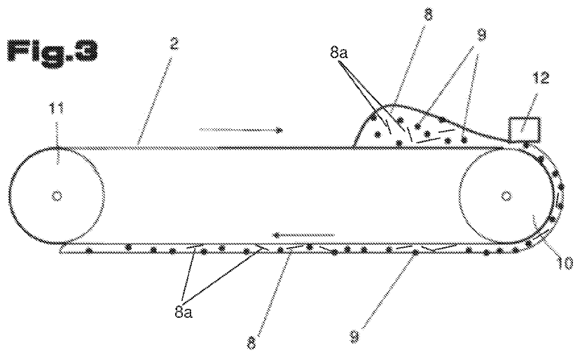

FIG. 3 a depiction of the production process according to the invention.

First of all, it is to be noted that in the different embodiments described, equal parts are pro- vided with equal reference numbers and/or equal component designations, where the disclo- sures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

In addition, it should be noted that the embodiments are described across figures.

According to FIGS. 1 and 2, an endless belt 1 according to the invention comprises a belt body 2 having a first main surface 3 and a second main surface 4. The first main surface 3 and the second main surface 4 of the belt body 2 are connected to each other via lateral edges 5, 6. The inner side of the endless belt 1 may be formed by the second main surface 4. A coating 7 is applied to the main surface 3 of the belt body 2 opposite the inner side of the endless belt 1.

The coating 7 forms an outer surface of the endless belt 1 and has a base material 8 into which reinforcing elements 8a are inserted. The reinforcing elements 8a may be designed as fibers, in particular mineral fibers, in particular glass fibers, carbon and/or plastic fibers and/or metal fibers and/or fibers based on natural raw materials, such as cellulose and/or hemp and/or nee- dles, in particular metal needles. The fibers may for example be formed or boron fibers, and/or glass and/or nylon (e.g. polyamide), and/or cotton and/or sisal and/or hemp and/or jute and/or flax and/or natural fibers (seed fibers, bast fibers, hard fibers, coir, rush grasses, bam- boo, etc.) and/or wood fibers and/or wool and/or animal hair and/or silk.

Moreover, the reinforcing elements 8a may form at least a long-range order, for example in the form of a mesh, grid, for example a wire grid, or fabric, such as an armoring fabric, in par- ticular in the form of a biaxial glass fabric, or in the form of a glass fiber scrim or carbon fiber scrim.

In the case of grids, fabrics or meshes, these preferably have a mesh size of 0.1 mm x 0.1 mm to 10 mm x 10 mm, wherein the formed meshes do not necessarily have to be designed to be rectangular/square, thus, the meshes may in general have any shape, e.g. diamond- deltoid-, parallelogram-shaped, etc. In case of a fabric, the longitudinal and/or transverse fibers may be made of the same or different materials and may be of the same or different thickness.

Moreover, the reinforcing elements 8a may be statistically distributed in the base material 8 and/or the coating 7, for example in the form of cotton flocks, glass fiber shavings, carbon fiber shavings, fibers or needles.

In case of a mesh, fabric, such as an armoring fabric, or a grid, the individual connected trans- verse and/or longitudinal fibers or transverse and/or longitudinal rods represent the reinforc- ing elements 8a.

Moreover, the reinforcing elements 8a may each have a ratio of length to diameter of at least 3:1, in particular of at least 5:1, preferably of at least 7:1, particularly preferred of at least 8:1.

A share of the reinforcing elements 8a may amount to between 10 and 45 percent by weight, in particular between 20 and 35 percent by weight, of the base material 8 or the coating 7.

The base material 8 may form a matrix into which hard particles 9 are embedded. The hard particles 9 are made of a material which can have a hardness measured according to Vickers of more than 500 [HV], in particular a hardness between 1400 [HV] and 10060 [HV]. The Vickers hardness values given in this document refer to a Vickers hardness test with a test force >49.03 N, in particular 49.03 N. In other words, the hard particles are made of a mate- rial that preferably has a Mohs hardness of above 5, in particular between 6 and 10. In this re- gard, the indication in Mohs hardness represents an alternative to the indication in Vickers hardness.

According to a preferred variant of the invention, the coating 7 is applied directly to the first main surface 3 of the belt body 2. The belt body 2 is preferably made of metal, in particular of steel.

The coating 7 may, for example, have a layer thickness of between 0.2 and 2 mm, in particu- lar of between 0.5 and 1.5 mm, and an average roughness depth of more than 100 μm, prefer- ably of more than 300 μm, particularly preferred of more than 500 μm. Moreover, the coat- ing 7 may be designed to be seamless and essentially homogeneous.

The endless belt 1 may have a circumferential length of between 0.2 and 30 m, in particular between 1 and 25 m, and a thickness of between 0.1 and 4 mm, in particular between 0.2 and 1.2 mm, and a width of between 0.1 and 10 m, in particular between 0.2 and 3.2 m.

The base material 8 may be formed of a polymer or a mixture of polymers. Preferably, the polymer or polymer mixture used is selected from the group of polyimide (PI), polypropylene

(PP), monoaxially oriented polypropylene (MOPP), biaxially oriented polypropylene (BOPP), polyethylene (PE), polyphenylene sulfide (PPS), polyetheretherketone (PEEK) polyether- ketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT) , polyethylene terephthalate (PET), polyamide (PA), polycarbonate (PC), cycloolefin copolymers (COC), polyoxymethylene (POM), acrylonitrile-butadiene-styrene (ABS), polyvinyl carbonate (PVC) ethylene tetrafluoroethylene (ETFE), polytetrafluoroeth- ylene (PTFE), polyvinyl fluoride (PVF), polyvinylidene fluoride (PVDF) and/or ethylene-tet- rafluoroethylene-hexafluoropropylene-fluoropolymer (EFEP). It is particularly preferred for the base material 8 to be formed from a thermoplastic polymer, wherein, however thermoset or elastomeric polymers can in principle also be used to realize the matrix formed from the base material 8.

The hard particles 9 may be formed by organic particles, in particular wheat grit, particles from nut shells, rice or particles from broken cherry stones, and/or inorganic particles, in par- ticular selected from the group, corundum (A12O3), ruby, sapphire, quartz (SiO2), topaz (A12[(F,OH)2|SiO4]), silicon carbide (SiC), diamond (C), boron nitride (BN), aggregated dia- mond nanorods (ADNR), ZrO2 and any possible dopants of ZrO2, in particular 8YSZ and 3 YSZ, sand, TiO2, metal or ceramic powders and inorganic agglomerates.

A medium grain size of the hard particles 9 preferably amounts to between 0.01 and 3 mm, preferably between 0.05 to 2 mm, particularly preferred between 0.1 and 1 mm The hard par- ticles 9 may be present as single particles or, as is often the case for finer grain sizes, in the form of agglomerates. The individual particles may be similar and have a regular geometric shape — for example spherical or cylindrical. However, the individual particles may also have an irregular shape and no similarities. An example of this is the production of powders by crushing and grinding, as is frequently used for ceramic particles. Powders produced in this way have a wide particle size distribution which is statistically distributed, the d50parameter being used as the mean value of the particle size. The mean diameter d50of such hard parti- cles 9 is between 0.01 to 3 mm, preferably between 0.05 to 2 mm, and particularly preferred between 0.1 to 1 mm A surface of the coating 7 may have, for example, 1 to 10000, prefera- bly 1 to 1000, particularly preferred 10 to 1000, hard particles per cm². In a dry and in a wet surface state, the coating 7 preferably has a slip resistance of R13 according to DIN-51130.

To produce the endless belt 1 according to the invention, the base material 8 is applied prefer- ably directly to the first main surface 3 of the belt body 2 according to FIG. 3. In this case, the base material 8 can be applied to the first main surface 3 of the belt body 2 in a liquid form, in particular in a viscous form, preferably in a viscous form with a dynamic viscosity of 10²- 10⁵ mPas, in particular 10⁴ — 10⁵ mPas. The reinforcing elements 8a may be inserted into the base material 8 before it is applied onto the first main surface 3 of the belt body 2. Hence, for example, fibers or small metal rods, in particular in the form of needles, may be admixed to the base material 8. In this regard, the reinforcing elements 8a may be statistically distributed in the base material 8 and/or in the coating 7. Alternatively, the (fiber- and/or rod- and/or nee- dle-shaped) reinforcing elements 8a may also be distributed on the belt body 2 before the ap- plication of the base material 8 and subsequently be coated with the base material 8.

According to another variant of the invention, the reinforcing elements 8a may have a long- range order and, for example, be present in the form of a mesh, grid or fabric, such as an ar- moring fabric. In this case, the reinforcing elements 8a may also be played on the first main surface 3 of the belt body 2 before the application of the base material 8 thereon and then be covered with the base material 8. Thus, the grid, mesh or fabric may also be applied to the belt first and the base material may be applied on top only afterwards. In this regard, said applica- tion of the grid, mesh or fabric onto the endless belt 1 may, for example, also be carried out “spirally” (to be precise: helically) in the circumferential direction of the endless belt 1. Thus, the grid, mesh or fabric forms a helical winding on the main surface 3 of the endless belt 1.

This has the advantage that the grid, fabric or mesh has no junction point in the transverse di- rection of the endless belt 1 but is applied so to say “endlessly”, whereby, of course, junction points between the individual belt section of the mesh, grid or fabric (i.e. in the longitudinal direction of the endless belt) exist, however, these are not loaded as would be the case for junction points in the transverse direction of the endless belt 1. In the just described embodi- ment, the width of the grid, fabric or mesh is smaller than the width of the endless belt 1.

It is also possible that first, one layer of the base material 8 is applied and the reinforcing ele- ments 8a are placed in the base material 8 on top thereof and subsequently are entirely cov- ered by a further layer of the base material 8. Moreover, in case of use of reinforcing elements 8a forming a grid or mesh, a joint application with the base material 8 may be carried out. Hence, the grid or mesh may be soaked in the base material 8 and be applied to the belt sur- face 2 along with the base material 8.

In case of use of reinforcing elements 8a not forming a long-range order, such as glass fiber shavings, the reinforcing elements 8a are preferably introduced together with the hard parti- cles 9 into the base material 8 and/or mixed with it, and then the base material 8 with the rein- forcing elements 8a and the hard particles 9 contained therein is, for example, applied with a doctor blade — the reinforcing elements 8a and the hard particles 9 are then statistically dis- tributed in the coating.

In contrast, when using nets/grids/fabrics, i.e. reinforcing elements 8a with a long-range order, these are preferably first placed/applied/glued onto the endless belt 1 and then the base mate- rial 8a consisting of matrix and hard particles 9 is applied, in particular applied with a doctor blade.

Preferably, the admixed mass of the reinforcing elements 8a amounts to between 10 and 45percent by weight, in particular between 20 and 35 percent by weight, of the base material 8 or the coating 7.

The structure of the reinforcing elements 8a may be recognized in the finished coating 7 as irregularities.

According to a preferred variant of the invention, the hard particles 9 are also already mixed into the base material 8 before an application of the base material 8 to the belt body 2. Alter- natively, however, the base material 8 with or without reinforcing elements 8a can first be ap- plied to the belt body 2 and then the hard particles 9 can be distributed in the already applied base material 8. For example, the hard particles 9 can be interspersed into the still wet base material 8. The hard particles 9 may be statistically distributed in the matrix formed from the base material 8.

The base material 8, the reinforcing elements 8a and the hard particles 9 can be distributed evenly on the first main surface 3 of the belt body 2 by means of a doctor blade 12, for exam- ple by means of a strip-shaped doctor blade.

Alternatively or in addition to the use of a doctor blade, the base material 8, the reinforcing elements 8a and/or the hard particles 9 can also be applied and distributed on the surface of the belt body 2 by rolling, trowelling, brushing, extruding or spraying. Coating of the belt body 2 with the base material 8 and the hard particles 9 by means of a curtain coating process is also possible.

As can be seen from FIG. 3, the belt body 2 may be closed to form an endless ring before the coating 7 is applied. If the belt body 2 is made of metal, it can preferably be closed to form the ring by welding, although other types of connection such as riveting would also be possi- ble in principle. The belt body 2 closed to form an endless ring may be circumferentially ar- ranged between two rollers 10, 11 before the coating 7 is applied.

The base material 8, the reinforcing elements 8a and/or the hard particles 9 may be applied to an upper run of the belt body 2 formed into a closed ring and distributed evenly on the upper run, for example, by means of the doctor blade 12. The belt body 2 can be moved further in a circumferential direction during or after the distribution of the base material 8 as well as the reinforcing elements 8a and the hard particles 9. After the base material 8 has dried, the rein- forcing elements 8a and the hard particles 9 are firmly embedded in it and the coating 7 formed from the dried base material 8 and the hard particles 9 is inseparably bonded to the first main surface 3 of the belt body 2 of the endless belt 1.

The coating 7 may be applied to the closed belt body 2 in a single web, or it may be applied in multiple webs. There may be a non-coated gap between the webs. Preferably, the belt body 2 is not coated all the way to the edge to allow control of the belt movement with a belt edge sensor. In the case of multiple webs, these may have different widths. However, the webs may also have different coatings 7 with regard to the composition of the matrix, the reinforcing el- ements 8a and the hard particles 9.

If necessary, a subsequent treatment could still be carried out in the wet or also in the dry state of the coating 7, for example by grinding, scratching, smoothing, polishing, skin pass, textur- ing. In particular, when a thermoplastic material 8 is used as the base material for the matrix, a subsequent heat treatment may be carried out to modify the surface after the coating 7 has dried. Such a heat treatment may include the entire surface such that the coating properties are globally changed - for example, the texture, homogeneity or residual stresses, etc. of the coat- ing 7 may be changed. If required, heat input can also be applied only locally in order to in- troduce possible local structuring, particularly in the case of a thermoplastic matrix.

In particular, it is also possible to apply the coating 7 in multiple layers and/or to retouch it locally.

Finally, as a matter of form, it should be noted that for ease of understanding of the structure, elements are partially not depicted to scale and/or are enlarged and/or are reduced in size.

### List of reference numbers

1 Endless belt

2 Belt body

3 Main surface

4 Main surface

5 Lateral edge

6 Lateral edge

7 Coating

8 Base material

8a Reinforcing elements

9 Hard particle

10 Roller

11 Roller

12 Doctor blade

1-31 (canceled).

32. A method for producing an endless belt (1) having a belt body (2), which comprises a first main surface (3) and a second main surface (4), wherein the first main surface (3) and the second main surface (4) of the belt body are connected to one another via lateral edges (5, 6), wherein a coating (7) is applied to the first main surface (3) of the belt body (2) being opposite to an inner side of the endless belt (1) in a finished state of the endless belt (1), wherein the coating (7) forms an outer side of the endless belt (1) in a finished state, wherein at least one base material (8), into which reinforcing elements (8a) are inserted, is applied to the first main surface (3) of the belt body (2) as the coating (7), wherein the base material (8) forms a matrix for hard particles (9), into which the hard particles (9), which comprise in particular of at least one material with a hardness measured according to Vickers of more than 500[HV], preferably with a hardness between 1400 [HV] and 10060 [HV], are embedded, wherein the coating (6) is preferably applied directly to the first main surface (3) of the belt body (2).

33. The method according to claim 32, wherein fibers, in particular mineral fibers, such as carbon fibers and/or boron fibers, and/or glass fibers and/or plastic fibers, such as nylon fibers (e.g. polyamide), and/or metal fibers and/or fibers based on natural raw materials, such as cellulose and/or hemp and/or cotton and/or sisal and/or jute and/or flax and/or natural fibers and/or wood fibers and/or wool and/or animal hair and/or silk, and/or as needles, in particular metal needles, are used as reinforcing elements (8a).

34. The method according to claim 32, wherein the reinforcing elements (8a) form at least a long-range order, for example in the form of a mesh, grid or fabric, in particular in the form of a biaxial glass fabric, a glass fiber scrim, a carbon fiber scrim, or may be statistically distributed in the base material, for example in the form of cotton flocks, glass fiber shavings, carbon fiber shavings.

35. The method according to claim 32, wherein the reinforcing elements (8a) may each have a ratio of length to diameter of at least 3:1, in particular of at least 5:1, preferably of at least 7:1, particularly preferred of at least 8:1.

36. The method according to claim 32, wherein a share of the reinforcing elements (8a) amounts to between 10 and 45 percent by weight, in particular between 20 and 35 percent by weight, of the base material (8) or the coating (7).

37. The method according to claim 32, wherein the base material (8) is made of at least one polymer or a mixture of polymers, in particular selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP), preferably a thermoplastic polymer.

38. The method according to claim 32, wherein organic particles, in particular wheat grit, particles from nut shells, rice or particles from broken cherry stones, and/or inorganic particles, in particular selected from the group, corundum (Al₂O₃), ruby, sapphire, quartz (SiO₂), topaz (Al₂[(F,OH)₂|SiO₄]), silicon carbide (SiC), diamond (C), boron nitride (BN), aggregated diamond nanorods (ADNR), ZrO₂, dopants of ZrO₂, in particular 8YSZ and 3 YSZ, sand, TiO₂, metal or ceramic powders and inorganic agglomerates, are used as the hard particles (9).

39. The method according to claim 32, wherein the belt body (2) is made of metal, wherein the belt body (2) is closed, in particular by welding, to form an endless ring before the coating (7) is applied.

40. The method according to claim 39, wherein the belt body (2), which is closed to form an endless ring, is circumferentially arranged between two rollers (10, 11) before the coating (7) is applied.

41. The method according to claim 32, wherein the base material (8) is applied in a liquid, in particular viscous form, preferably in viscous form with a dynamic viscosity of 10²— 10⁵ mPas, in particular 10⁴— 10⁵ mPas, preferably together with the reinforcing elements (8a) and the hard particles (9), to the first main surface (3) of the belt body (2) and is distributed uniformly on the first main surface (3) of the belt body (2), in particular by means of a doctor blade (12), preferably by means of a strip-shaped doctor blade.

42. The method according to claim 40, wherein the base material (8) and the reinforcing elements (8a) as well as the hard particles (9) are applied to an upper run of the belt body (2) formed into a closed ring and distributed uniformly on the upper run, in particular by means of the doctor blade (12), wherein the belt body (2) is moved further in a circumferential direction during or after the distribution of the base material (8) and the hard particles (9).

43. The method according to claim 32, wherein the hard particles (9) and the reinforcing elements (8a) are mixed into the base material (8) forming the matrix for the hard particles (9) prior to application to the first main surface (3) of the belt body (2).

44. The method according to claim 32, wherein the base material (8), in particular the base material (8) with the reinforcing elements (8a) and the hard particles (9) are sprayed, brushed, rolled and/or troweled onto the first main surface (3).

45. The method according to claim 32, wherein the hard particles (9) have a grain size of between 0.01 mm and 3 mm, preferably between 0.05mm and 2 mm, particularly preferred between 0.1 mm and 1 mm.

46. An endless belt, in particular an endless belt (1) produced according to claim 32, having a belt body (2), which comprises a first main surface (3) and a second main surface (4), wherein the first main surface (3) and the second main surface (4) of the belt body (2) are connected to one another via lateral edges (5, 6), wherein a coating (7) is applied to the first main surface (3) of the belt body (2) being opposite to an inner side of the endless belt (1), wherein the coating (7) forms an outer side of the endless belt (1), wherein the coating (7) has a base material (8) into which reinforcing elements (8a) are inserted, wherein the base material (8) forms a matrix, into which hard particles (9), in particular of at least one material with a hardness measured according to Vickers of more than 500 [HV], preferably with a hardness between 1400 [HV] and 10060 [HV], are embedded, wherein the coating (7) is preferably applied directly to the first main surface (3) of the belt body (2).

47. The endless belt according to claim 46, wherein the reinforcing elements (8a) are designed as fibers, in particular mineral fibers, such as carbon fibers and/or boron fibers, and/or glass fibers and/or plastic fibers, such as nylon fibers (e.g. polyamide), and/or metal fibers and/or fibers based on natural raw materials, such as cellulose and/or hemp and/or cotton and/or sisal and/or hemp and/or jute and/or flax and/or natural fibers and/or wood fibers and/or wool and/or animal hair and/or silk, and/or as needles, in particular metal needles.

48. The endless belt according to claim 46, wherein the reinforcing elements (8a) form at least a long-range order, for example in the form of a mesh, grid or fabric, in particular in the form of a biaxial glass fabric, a glass fiber scrim, a carbon fiber scrim, or may be statistically distributed in the base material (8), for example in the form of cotton flocks, glass fiber shavings, carbon fiber shavings.

49. The endless belt according to claim 46, wherein the reinforcing elements (8a) may each have a ratio of length to diameter of at least 3:1, in particular of at least 5:1, preferably of at least 7:1, particularly preferred of at least 8:1.

50. The endless belt according to claim 46, wherein a share of the reinforcing elements (8a) amounts to between 10 and 45 percent by weight, in particular between 20 and 35 percent by weight, of the base material (8) or the coating (7).

51. The endless belt according to claim 46, wherein the base material (8) is made of at least one polymer or a mixture of polymers, in particular selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP), preferably a thermoplastic polymer.

52. The endless belt according to claim 46, wherein the hard particles (9) are organic particles, in particular wheat grit, particles from nut shells, rice or particles from broken cherry stones, and/or inorganic particles, in particular selected from the group, corundum (Al₂O₃), ruby, sapphire, quartz (SiO₂), topaz (Al₂[(F,OH)₂|SiO₄]), silicon carbide (SiC), diamond (C), boron nitride (BN), aggregated diamond nanorods (ADNR), ZrO₂, dopants of ZrO₂, in particular 8YSZ and 3 YSZ, sand, TiO₂, metal or ceramic powders and inorganic agglomerates.

53. The endless belt according to claim 46, wherein the hard particles (9) have a grain size of between 0.01 mm and 3 mm, preferably between 0.05mm and 2 mm, particularly preferred between 0.1 mm and 1 mm.

54. The endless belt according to claim 46, wherein a surface of the coating (7) comprises 1 to 10000, preferably 1 to 1000, particularly preferred 10 to 1000,hard particles per cm².

55. The endless belt according to claim 46, wherein the coating (7) has a slip resistance of R13 according to DIN-51130 in a dry and in a wet surface condition.

56. The endless belt according to claim 46, wherein the belt body (2) is made of metal, in particular of steel.

57. The endless belt according to claim 46, wherein the coating (7) has a layer thickness of between 0.1 mm and 5 mm, in particular of between 0.5 mm and 1.5 mm.

58. The endless belt according to claim 46, wherein the coating (7) has an average roughness depth of more than 100 μm, preferably of more than 300 μm, particularly preferred of more than 500 μm.

59. The endless belt according to claim 46, wherein the endless belt (1) has a circumferential length of between 0.2 m and 30 m, in particular between 1 m and 25 m and a thickness of between 0.1 mm and 4 mm, in particular between 0.2 mm and 2.5 mm and a width of between 0.1 m and 10 m, in particular between 0.2 m and 3.2 m.

60. The endless belt according to claim 46, wherein the coating (7) is seamless.
